(19) United States
(12) Patent Application Publication
(10) Pub. No.: US 2022/0079172 A1
(43) Pub. Date: Mar. 17, 2022

(54) BAKED GOODS CONTAINING NON-DAIRY PROTEIN

(71) Applicant: Ripple Foods, PBC, Berkeley, CA (US)

(72) Inventor: Manoj KUMAR, San Ramon, CA (US)

(73) Assignee: Ripple Foods, PBC, Berkeley, CA (US)

(21) Appl. No.: 17/023,604

(22) Filed: Sep. 17, 2020

(51) Int. Cl. A21D 13/066; A23J 3/16; A23J 3/18; A21D 10/04; A23L 33/185; A23L 33/20

(52) U.S. Cl. CPC A21D 13/066; A23J 3/16; A23J 3/18; A21D 13/80; A23L 33/185; A23L 33/20; A21D 10/04

(57) ABSTRACT

Disclosed are baked goods containing non-dairy protein. Examples of the disclosed baked goods include quick breads. An example quick bread includes muffins that contain salt-precipitated plant proteins (e.g., from pea) at levels surpassing 9 or more grams per 90-gram muffin. The muffins are fully formed (i.e., not collapsed), are neutral in flavor with no bitter aftertaste and are hypoallergenic or non-allergenic. In some examples, the baked goods are vegetarian, do not contain eggs, or are vegan. In some examples, the only source of protein in the baked goods comes from plant proteins.

### BACKGROUND

There are many different types of baked goods. Generally, a formulation for making a baked good contains at least a flour and a liquid, mixed into a batter or dough, which may be leavened, and then is baked. Baked goods may contain protein. In some examples, baked goods may contain dairy or non-dairy protein. High amounts of some non-dairy, plant-based proteins may not result in good quality baked goods. In some examples, baked goods containing high amounts of plant-based protein may not form properly (e.g., they may collapse), and/or may not exhibit an appearance, aroma, texture or taste that is desired by the consumer. Furthermore, some plant protein-based high-protein baked goods, such as from soybean, tree nuts, and peanuts, cause allergies in certain human populations. There is a growing need for high protein content baked goods made from nonallergenic or hypoallergenic non-dairy protein.

### SUMMARY

Baked goods (e.g., quick breads, including muffins) have been made that have high amounts of non-dairy protein. The baked goods are formed (i.e., not collapsed) and have good appearance, aroma, texture and taste. The baked goods may exceed 9, 10, 11, 12, 13 or more grams of non-dairy protein per 90 grams of baked good product. The non-dairy protein used in the baked goods may be obtained from plant sources. Generally, the non-dairy protein is non-allergenic or hypoallergenic. In some examples, the plant source may be pea. In some examples, the non-dairy protein used to make the baked goods may have an aqueous solubility of less than about 15% (w/w). In some examples, the non-dairy protein may have a solution pH of less than about 7.1. In some examples, the non-dairy protein may have a sodium content of less than about 4500 ppm. In some examples, the non-dairy protein used to make the baked goods may be salt-precipitated. In some examples, the non-dairy protein may be salt precipitated at an acidic pH.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

The following U.S. patents and U.S. published patent applications are each incorporated by reference in their entirety into this application:

U.S. Patent Publication No. 2019/0000112 A1 (Ser. No. 16/068,567), published Jan. 3, 2019 and titled, “Product Analogs or Components of Such Analogs and Processes for Making Same.”

Other references incorporated by reference may be listed throughout the application.

### BRIEF DESCRIPTION OF THE DRAWINGS

In the accompanying drawings, which are incorporated in and constitute a part of the specification, embodiments of the disclosed inventions are illustrated. It will be appreciated that the embodiments illustrated in the drawings are shown for purposes of illustration and not for limitation. It will be appreciated that changes, modifications and deviations from the embodiments illustrated in the drawings may be made without departing from the spirit and scope of the invention, as disclosed below.

FIGS. 1A, 1B and 1C illustrate examples of muffins made with different sources and/or amounts of non-dairy protein. The muffins of FIGS. 1A, 1B and 1C are as described in Example 2 and Example 4 herein.

### DETAILED DESCRIPTION

### Definitions

Unless defined otherwise, all technical and scientific terms used herein have the same meaning as commonly understood by one of ordinary skill in the art to which the present invention pertains. It is to be understood that the terminology used herein is for describing particular embodiments only and is not intended to be limiting. For purposes of interpreting this disclosure, the following description of terms will apply and, where appropriate, a term used in the singular form will also include the plural form and vice versa.

Herein, “adhesiveness” refers to the amount of work necessary to overcome attractive forces of a food to another contact surface. This property may be experienced as gooeyness, stickiness, tackiness, and the like.

Herein, “allergenic” means having the capability to induce allergy. “Non-allergenic” means not capable of causing allergy. “Hypoallergenic” means having a reduced ability to induce allergy. Generally, allergens are allergenic. In some examples, allergens refer to 8 significant food allergens recognized in the United States, including milk (including whey protein and/or caseinate), eggs, fish, crustacean shellfish, tree nuts, peanuts, wheat and soybeans.

Herein, “aqueous solubility” refers to the maximum amount of a substance (e.g., refined protein preparation) that can be dissolved in water at a given temperature.

Herein, “baked goods” generally refers to foods that result from baking batters and/or doughs. Example baked goods may include, but not be inclusive of bagels, barmbrack, biscotti, biscuits, bread, bread rolls, brownies, buns, cakes, cookies, cornbread, crackers, croissants, crumpets, crusts, cupcakes, doughnuts, English muffins, flatbreads, muffins, pandesals, pastries, pies, pittas, potato breads, pretzels, puff pastries, quick breads, scones, shortbread, soda breads, sourdoughs, tarts, tortes, toasts, twice-baked foods and viennoiseries. Herein, unleavened breads, like arepa, bannock, bataw, kitcha, lavash, matzo, rieska, roti, tortilla, tortilla de rescoldo and the like.

Herein, “baking” refers to food preparation methods that use dry heat (e.g., in an oven). In some examples, heat from an oven causes batters or doughs to become baked goods.

Herein, “batter” refers to a liquid mixture of ingredients used to make baked goods. The ingredients generally include flour, liquid and other ingredients. Generally, batters have a lower amount of flour to liquid than doughs. The consistency of batter ranges from pourable to sticky.

Herein, “binder” refers to a substance or substances capable of holding a food together. Generally, the binder may hold edible particles (e.g., refined protein preparations) together.

Herein, “bread” generally refers to a baked good that is a combination of flour and liquid that is shaped as a loaf.

Herein, “carbohydrate” includes sugar, starch, oligosaccharides, and cellulose. Herein, carbohydrates are generally from non-animal sources.

Herein, “cellulose” refers to D-glucose units joined by (1→4)-glycosidic bonds.

Herein, “chewiness” as used herein refers to the energy required to chew solid food until it can be swallowed. Chewiness may be determined using texture profile analysis (TPA) testing.

Herein, “cohesiveness” as used herein refers to a measure of the strength of internal bonds making up the body of the product and tendency of product to remain together, and resist breaking into several pieces, during compression. In some examples, this is the extent to which a food deforms when compressed. Generally, cohesiveness is determined using texture profile analysis (TPA) testing.

Herein, “collapse” refers to a structure that has fallen and/or given way.

Herein, “coloring agent” generally refers to a substance that imparts a color to another substance. Herein, coloring agents may be used to impart a desirable color to a baked good.

Herein, “compress” means to make something smaller. One type of food compression uses a vacuum to remove or decrease the amount of air in a food.

Herein, “cupcake” refers to a small domed baked good. The formulation of ingredients for a cupcake may be like the formulation used for a muffin. In some examples, cupcakes may use all-purpose flour. In some examples, muffins may use whole-wheat, oat or various nut flours. In some examples, cupcakes may use butter. In some examples, muffins may use oil. In some examples, a batter used to make a cupcake may be smooth and fluffy and may be beaten longer than a batter used to make muffins (e.g., muffin batter may be relatively “lumpy”).

Herein, “dairy” refers to food containing or produced from the milk of mammals.

Herein, “density” refers to mass per unit volume. Generally, density references the degree of compactness of a substance (e.g., a baked good).

Herein, “dough” refers to a thick, malleable mixture of ingredients used to make baked goods. The ingredients generally include flour, liquid and other ingredients. Generally, doughs have a higher amount of flour to liquid than batters. The consistency of dough is dry enough to be handled and kneaded.

Herein, “edible” means fit to be eaten.

Herein, an “egg” is laid by a female bird, reptile, fish or invertebrate. Herein, egg may refer to a chicken egg.

Herein, “emulsifier” refers to substances that stabilize emulsions.

Herein, “exterior layer” refers to a thickness of material on the outside of a food (e.g., a baked good).

Herein, “fat” generally refers to lipids. Herein, fat includes both fats and oils. Herein, fats generally refer to non-animal fats.

Herein, “flavoring agent” refers to a substance that imparts flavor to another substance. Herein, flavoring agents may be used to make product a more natural taste.

Herein, “flour” refers to a powder obtained by grinding grain (e.g., wheat) and used to make baked goods. Flour may be a fine powder.

Herein, “food” refers to something edible. Food may include baked goods.

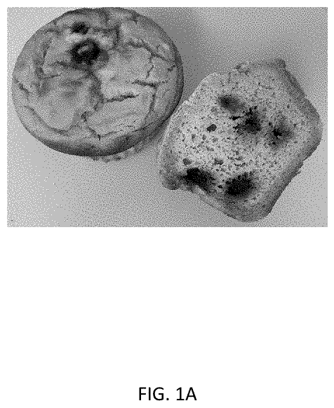

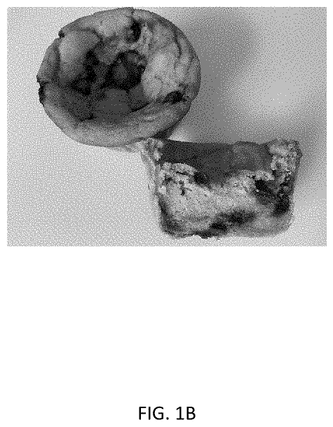

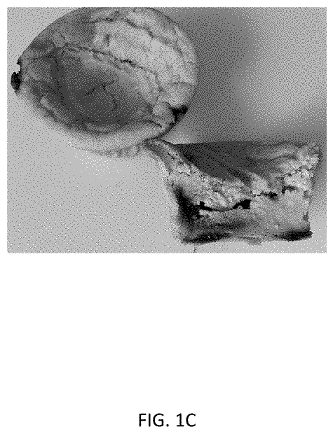

Herein, “formed” refers to a bake good that is not collapsed. Collapsed baked goods are shown in FIGS. 1B and 1C.

Herein, “fracturability” refers to the force at first peak, using texture profile analysis (TPA) testing.

Herein, “gluten” refers to a group of proteins (e.g., gliadin and glutenin) present in cereal grains (e.g., wheat) that, when in a dough, contribute to its elastic texture.

Herein, “hardness” refers to maximum force achieved at the first bite or first compression, using texture profile analysis (TPA) testing.

Herein, “homogeneous” refers to a uniform composition. Herein, baked goods may be referred to as homogeneous in the sense that any edible particles or inclusions in the baked good are relatively small. For example, refined protein used in the baked goods described here may be in the form of a powder, and when formed into a batter/dough, or in the baked good product, particles of the protein are generally indistinguishable from the rest of the formulation or baked good by the human eye. In contrast, a baked good containing visible inclusions (e.g., dried fruits, nuts, seeds, flavored chips, etc.) are generally not considered as homogeneous in this disclosure. Therefore, the word “homogeneous” as used herein to refer to the disclosed baked goods, generally refers to visually homogeneous, using the human eye.

Herein, “inclusions” refer to a body or particle recognizably distinct from the substance in which it is embedded. Herein, inclusions in a baked good are generally of a size that are detectable visually, using the human eye. The muffins shown in FIGS. 1A, 1B and 1C are examples of baked goods containing inclusions, as defined herein. The inclusions in those muffins are blueberries.

Herein, “isolated protein” or “protein isolate” refers to a protein or population of proteins that are substantially isolated from a source. That is, non-protein components have been substantially removed or at least reduced in a preparation of isolated proteins. In some examples, components that may be removed may include insoluble polysaccharide, soluble carbohydrate, ash, other minor constituents and other components. Generally, herein, isolated protein refers to a population of proteins from one or more plant sources. Isolated protein may be in variety of forms, including for example, protein isolate, protein concentrate, protein flour, meal and/or combinations thereof.

Herein, “leaven” refers to causing a batter or dough to rise or expand. Often, rising or expansion is caused by gas that forms pockets in the batter or dough. A baked good that comes from a batter or dough that has risen or expanded as above may be referred to as “leavened.”

Herein, “leavening agent” refers to substances that release gases within and cause expansion of batters or doughs. Leavening agents are responsible for the porous structure of many baked goods. Example leavening agents include chemical leavening agents (e.g., baking powder, baking soda, cream of tartar, etc.), biological leavening agents (e.g., yeast), and vaporous leavening agents (e.g., steam, air). In some examples, egg whites may produce a foam that retains its structure during baking. Eggs may be considered a leavening agent in some instances.

Herein, “meal” is like flour, except it has not been ground as finely as flour (i.e., meal has a larger grain or particle size than flour).

Herein, “milk” refers to milk from a mammal (i.e., dairy milk). Milk from a non-animal source is generally referred to as non-dairy milk. Plant-based milk is a type of non-dairy milk.

Herein, “mouthfeel” refers to physical sensations in an individual's mouth caused by food, as opposed to taste of the food. In combination with taste and smell, mouthfeel determines the overall flavor of a food. Mouthfeel is sometimes also called “texture”.

Herein, “muffin” refers to a small domed baked good. A muffin is a type of quick bread. There are many kinds of muffins. Some examples of different kinds of muffins include banana, blueberry, chocolate chip, corn, streusel-topped and the like. In some examples, muffins have a texture and/or consistency that is denser than cupcakes. Muffins may be savory. Cupcakes may be sweet.

The term “non-dairy” as used herein means that the product or formulation has no dairy-based ingredients or less than 0.5% by weight of dairy-based ingredients. The term “substantially non-dairy” as used in the present disclosure means that the product or formulation has less than 5% by weight of dairy-based ingredients.

Herein, “nongluten” or “gluten free” means lacking or having a reduced amount of gluten.

Herein, “particle,” refers to small localized object or entity.

Herein, “particle size” generally refers to a D×50 measurement (e.g., in μm) for a population of particles having a distribution of sizes.

Herein, “product” refers to something that is made or processed.

Herein, “protein” refers to a chain or polymer of amino acids, covalently joined by peptide bonds.

Herein, “quick bread” refers to a bread that uses leavening agents other than yeast. The leavening agents used in quick breads allows for immediate baking after mixing the batter or dough. Non-limiting examples of quick breads include many cakes, brownies and cookies, as well as banana bread, beer bread, biscuits, cornbread, donuts, loaf breads, muffins, pancakes, scones, soda bread and waffles. In some examples, quick breads may not contain eggs. In some examples, eggs may be whipped to incorporate air and act as a leavening agent.

Herein, “refined protein” refers to isolated protein that has been processed.

Herein, “resilience” is how well a food regains its original height after compression. Resilience may be determined using texture profile analysis (TPA) testing.

Herein, “salt” refers to a compound made by joining a positively charged acid with a negatively charged base.

Herein, “salt-precipitated protein” refers to refined plant protein made by the process described herein and in U.S. Patent Publication No. 2019/0000112 A1 (Ser. No. 16/068,567), published Jan. 3, 2019 and titled, “Product Analogs or Components Of Such Analogs And Processes For Making Same.” Protein prepared using a process for salt precipitation that uses, for example, a calcium salt may be called “calcium-precipitated protein.”

Herein, “solid” refers to firm and stable in shape; not liquid or fluid.

Herein, “solution pH” refers to pH of water into which an amount of refined protein preparation has been dissolved. Herein, the pH of 10% (w/w) supersaturated solutions of refined protein preparations were determined.

Herein, “source,” refers to the origin of something or the place where something was obtained.

Herein, “springiness” is the degree to which food returns to its original dimensions after being compressed. Springiness may be determined using texture profile analysis (TPA) testing.

Herein, “starch” refers to D-glucose units joined by α(1→4)-glycosidic bonds. Starch contains amylose and amylopectin.

Herein, “sugar” refers to sweet-tasting, soluble carbohydrates. Some example sugars include the disaccharides, sucrose (glucose and fructose) lactose (glucose and galactose) and maltose (two molecules of glucose). Example simple sugars, called monosaccharides, include glucose, fructose, allulose, and galactose. Generally, sugars are sweetening agents.

Herein, “sweetening agent” refers to a substance capable of imparting a taste or flavor characteristic of sugar, honey, and the like, to food. Sweetening agents may include non-caloric sweeteners such as aspartame, saccharin, stevia, monk fruits and protein-based sweeteners. Sweet is a taste sensation that is not bitter, sour or salty.

Herein, “texture” means the appearance, feel and/or consistency of a substance or surface. Regarding food, texture may be defined as the properties of a food that include physical characteristics that come from structural elements of the food which are generally sensed by touch and are related to deformation, disintegration and flow of the food under a force. Some parameters of texture include adhesiveness, chewiness, cohesiveness, fracturability, gumminess, hardness, resilience and springiness. In some examples, some of these parameters may be determined by a Texture Profile Analysis (TPA), using an example instrument called a texture analyzer. Also see “mouthfeel” herein.

Herein, “thickening agent” refers to a substance that increases the viscosity of a liquid. Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

Herein, “vegan” means using or containing no animal products. Vegan normally excludes eggs. Vegan that includes eggs may be called “ovo-vegetarian.”

Herein, “vegetable” means any plant, part of which is used for food or an edible part of a plant. Vegetable may also be defined as any plant part consumed for food that is not a fruit or seed but including mature fruits that are eaten as part of a main meal.

Herein, “vegetarian” means using or containing no fish, meat or poultry. Vegetarian does not exclude eggs.

Herein, “yeast” refers to a microorganism (i.e., fungus) that is generally used as a leavening agent in baked goods. In some examples, a yeast may be Saccharomyces cerevisiae.

### Baked Goods

This disclosure relates to baked goods. The disclosed baked goods contain non-dairy protein. In some examples, the baked goods may be non-vegetarian. In some examples, the baked goods may be vegetarian. In some examples, the baked goods may contain eggs. In some examples, the baked goods may not contain eggs. In some examples, the baked goods may be non-vegan. In some examples, the baked goods may be vegan. Generally, the baked goods are formulated as a batter or dough and are baked to yield the baked good.

In some examples, there may be limits on the amount of protein from certain non-dairy sources that can be formed into baked goods (i.e., higher amounts of protein may not result in a desired baked good or baked good of good quality). In some examples, increasing amounts of non-dairy protein in a baked good may result in the baked good not forming an expected shape (e.g., typical shape of a muffin). In some examples, a baked good may collapse, as shown for the muffins in FIGS. 1B and 1C. In some instances, it may be possible to remedy this situation by using different types or amounts of ingredients other than protein in the baked good (e.g., binders, leavening agents), by changes to mixing the ingredients and/or baking time or temperature. However, these changes may result in one or more undesired other properties of the baked good. In some examples, the resulting baked good may have an undesirable calorie content, taste, texture, appearance and/or other properties.

In some examples, the baked goods may be baked goods known as quick breads. Non-limiting examples of quick breads include many cakes, brownies and cookies, as well as banana bread, beer bread, biscuits, cornbread, donuts, loaf breads, muffins, pancakes, scones, soda bread, waffles and others.

Herein, we show that certain types of non-dairy protein are better able to form baked goods (e.g., muffins) at higher protein levels. In some examples, salt-precipitated plant protein, as described herein and in U.S. Patent Publication No. 2019/0000112 A1 (Ser. No. 16/068,567), published Jan. 3, 2019 and titled, “Product Analogs or Components of Such Analogs and Processes for Making Same” may form baked goods with higher protein content than possible with other refined proteins.

In some examples, achieving a particular level (e.g., a higher level) of non-dairy sourced protein in a baked good that forms an expected shape may be related to one or more of aqueous solubility, solution pH and sodium content of the refined non-dairy protein used in the baked good.

### Ingredients

Generally, the ingredients used in the disclosed baked goods are formulated into a batter or dough, and the batter or dough are baked to yield the baked good.

In some examples, the ingredients used in the baked goods disclosed herein may include various carbohydrates, non-dairy and/or plant-based protein, plant-based fats, including plant based oils, emulsifiers, leavening agents, sweetening agents, salt, thickening agents, flavoring agents, binding agents, coloring agents, water, vitamins and/or other nutritional supplements, enzymes, and other ingredients.

Generally, the amount of an ingredient or ingredients in a formulation or final baked good product is given in “percent by weight” or “weight percent” of a composition. The weight percent of various ingredients may refer to the amount of the ingredient in the formulation for making a baked good (e.g., batter or dough) and/or in the baked good itself. In some examples, the amount of an ingredient, especially in a final baked good product, may be given as a weight or mass (e.g., in grams) per a specific weight or mass of a baked good product (e.g., per 90 grams of a muffin). Given one form expressing an ingredient amount (e.g., weight percent, or mass or weight of a specific ingredient per total mass or weight of formulation or baked good), the other form of expressing an ingredient amount can be calculated.

Generally, the ingredients described in the sections below are grouped by chemical category (e.g., carbohydrate, protein, fat). In some examples, however, ingredients are grouped into functional categories (e.g., emulsifier, leavening agent, sweetening agent, thickening agent, flavoring agent). In some examples, an ingredient grouped in a chemical category may have one or more activities of one or more of the functional categories (e.g., some carbohydrate starches may have emulsifier activity), even though the ingredient is not listed as part of the functional category. In some examples, an ingredient grouped in a functional category may contain chemical substances that could be grouped into one or more chemical categories. In some examples, an ingredient grouped in a chemical category may contain substances from one or more other chemical categories. In some examples, an ingredient grouped in a functional category may have at least some activity that could be grouped in other functional categories. Grouping an ingredient in one category may not preclude that it may have chemical composition and/or activity that could be classified in a different category.

In some examples, the baked goods disclosed herein may include about or include no more than about 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295 or 300 calories per 90 grams of the baked goods.

### Carbohydrates

Herein, “carbohydrate” includes sugars, starch and cellulose. Carbohydrates may be monosaccharides, disaccharides, oligosaccharides or polysaccharides. Sugars may include polyols/sugar alcohols. Carbohydrates may be digestible or may be indigestible or poorly digestible. Herein, carbohydrates are generally from non-animal sources. In some examples, the carbohydrates used in the baked goods disclosed herein may be from plant sources. Carbohydrates may function as sweeteners, binders, fiber sources, moisture-holders, texture-modifiers, and may serve other functions in the disclosed baked goods. In some examples, a single source of carbohydrate may be used in the disclosed baked goods. In some examples, 2, 3, 4, 5, 6, 7, 8, 9 or 10 different sources and/or types of carbohydrates may be used in the disclosed baked goods.

In some examples, the carbohydrates used herein may be from any plant source. In some examples, the carbohydrates used herein may be from arracacha, arrowroot, canna, cassava (e.g., tapioca), chickpeas, corn, favas, lentils, maize, mung beans, peas, maize, millet, nuts, potatoes, rice, sago, sorghum, sweet potatoes, taro root, rye, yams, waxy maize, soy and others.

In some examples, the carbohydrates used herein may specifically exclude one or more plant sources. In some examples, the carbohydrates used in the baked goods disclosed herein may exclude one or more of carbohydrates from arracacha, arrowroot, canna, cassava (e.g., tapioca), chickpeas, corn, favas, lentils, maize, mung beans, peas, maize, millet, potatoes, rice, sago, sorghum, sweet potatoes, taro root, rye, yams, waxy maize, soy and others.

Carbohydrates may be in solid or liquid form. Carbohydrates may be water soluble or non-water soluble. Carbohydrates may be in the form of a flour. Carbohydrates may be in the form of a meal. Carbohydrates may be in the form of a powder. Carbohydrates may be in the form of a syrup. Carbohydrates may be in other forms. In some examples, carbohydrates in one or more of the indicated forms may be specifically excluded from use in the baked goods disclosed herein.

In some examples, flour may be sourced from one or more of the plant sources listed above. In some examples, flour may be sourced from cereal grains or other starchy food sources, like almond, amaranth, arrowroot, atta, banana, barley, buckwheat, cassava, chickpea, coconut, corn (e.g., cornstarch or fine cornmeal), fava bean, millet, mung bean, nuts (e.g., Brazil nut, cashew, macadamia, pistachio), oats, quinoa, potatoes, rice, rye, spelt, sorghum, soybean, sweet potatoes, taro root, teff, triticale, wheat, yellow pea, urad dal, and others. In some examples, flour from one or more of these sources may be specifically excluded from use in the disclosed baked goods. In some examples, flour may be from non-allergenic or hypoallergenic sources. Flour generally may contain carbohydrate. Flour may contain protein.

Non-limiting types of flour used may include all-purpose flour, cake flour, germ flour, graham flour, maida, pastry flour, self-rising flour, white flour, whole wheat flour, and others. One or more types of these flours may be excluded from use in the baked goods disclosed herein.

Example carbohydrates used in the disclosed baked goods may include corn syrup, corn fiber, high fructose corn syrup, tapioca syrup, crystalline fructose, tagatose, sucrose, lactose, maltose, galactose, xylose, dextrose, cyclodextrins, trehalose, raffinose, stachyose, fructooligosaccharide, maltodextrins, starches, pectins, gums, carrageenan, inulin, or cellulose based compound, or various sugar alcohols, including sorbitol, mannitol, maltitol, xylitol, lactitol, isomalt, erythritol or others.

Example carbohydrates used in the disclosed baked goods may include glucose, sucrose, fructose, dextrose, lactose and maltose. Carbohydrate sucrose, cocoa butter, high-fructose corn syrup, peanut butter, nuts, maltodextrins, isomalitulose, maltitol syrups, sorbitol syrups and mixtures thereof. Example carbohydrates used in the disclosed baked goods may include polydextrose, xylose, xylitol, sorbitol, cyclodextrins, trehalose, raffinose, stachyose, fructooligosaccharide, maltose, pectins, gums, carrageenan, inulin, hydrogenated indigestible dextrins, hydrogenated starch hydrolysates, highly branched maltodextrins and cellulose.

The carbohydrate preparations used herein as ingredients of the baked goods disclosed herein may contain at least 5, 10, 15, 20, 25, 30, 35, 40, 45, 50, 55, 60, 65, 70, 75, 76, 77, 78, 79, 80, 81, 82, 83, 84, 85, 86, 87, 88, 89, 90, 91, 92, 93, 94, 95, 96, 97, 98 or 99% carbohydrate, as defined above. The carbohydrate ingredients may contain other components like, for example, ash, calcium, fat, heavy metals, iron, magnesium, potassium, protein, sodium, vitamins and others.

In some examples, the carbohydrates used herein may be modified. Starch, for example, may be modified by physical and/or chemical means. Some examples of physical modification may include superheating, dry heating, osmotic pressure treatment, multiple deep freezing and thawing, instantaneous controlled pressure-drop process, stirring ball milling, vacuum ball milling, pulsed electric fields treatment, corona electrical discharges and others. Chemical modification may include adding new or modifying existing moieties in the carbohydrate. In some examples, the modifications may be introduced at hydroxyl groups of carbohydrates. Modifications may involve chemical derivatization, like etherification, esterification, acetylation, cationization, oxidation, hydrolysis, cross-linking and others.

Modified starch, for example, may have enhanced properties. Example enhanced properties may include enhancements in color, dispersion, emulsion stabilization and/or encapsulation, flavor, gelling, melting, solubility, texture, thermal stability, viscosity and others.

The starch used in the baked goods may be a single type of starch (e.g., from a particular plant, or a particular commercial source) or may be combinations of multiple types of starch, for example, 2, 3, 4, 5, 6, 7, 8, 9, 10 or more types of starch. In some examples, one or more specific starches may be excluded.

In some examples, carbohydrates may be included in the baked good formulations and/or final baked goods at amounts that are about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84 or 85 percent by weight of the baked good.

In some examples, carbohydrates may be included in the baked good formulations and/or final baked goods at amounts that are no more than, or no less than, about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 percent by weight of the baked good.

In some examples, carbohydrates may be included in the baked good formulations and/or final baked goods at amounts that are about or between about 1-80 percent by weight. In some examples, starch may be included at amounts about or between about 1-40, 2-60, 2-55, 2-50, 2-45, 2-40, 2-38, 2-35, 3-30, 3-36, 4-60, 4-55, 4-50, 4-45, 4-40, 4-35, 4-30, 4-25, 5-32, 6-60, 6-55, 6-50, 6-45, 6-40, 6-35, 6-30, 7-28, 8-26, 8-24, 8-20, 8-16, 9-30, 9-28, 9-24, 10-35, 10-30, 10-28, 10-25, 10-22, 10-20, 10-14, 11-35, 11-30, 11-25, 11-20, 11-15, 12-30, 12-25, 12-20, 12-18, 13-45, 13-35, 13-30, 13-25, 13-20, 14-30, 14-28, 14-26, 14-24, 14-22, 15-30, 15-25, 15-20, 16-25, 17-25, 17-20, 18-25, 18-24, 20-25 percent by weight and others.

In some examples, maltodextrin may be used as an ingredient of the baked goods disclosed herein. In some examples, maltodextrin may be used at amounts about or between about 1-5 percent by weight.

### Isolated and Refined Protein

Herein, “protein” refers to a chain or polymer of amino acids, covalently joined by peptide bonds. Herein, proteins are generally non-dairy proteins. Generally, proteins used in the baked goods disclosed herein contain non-dairy proteins from plants. Proteins from any plant may be used in the baked good formulations and products described herein. Various plant proteins used may be from almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat, white bean, yellow pea and others.

In some examples, one or more specific plant proteins or plant protein sources may be excluded from the baked goods disclosed herein. In various examples, proteins from almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat, white bean, yellow pea and others may be specifically excluded.

Plant proteins may be from one type of plant or from multiple plants. Other suitable plant protein isolates are also acceptable. In some examples, the plant protein component may include gluten as part of the plant protein. In some examples, the baked goods disclosed herein do not contain gluten.

In some examples, baked goods disclosed herein may contain proteins from only one plant protein source. In some examples, the baked goods may contain proteins from 2, 3, 4, 5, 6, 7, 8, 9 or 10 plant protein sources.

In some examples, specific sources of plant proteins may be excluded from the plant proteins used in the baked goods disclosed herein. In some examples, plant proteins from one, or from 2, 3, 4, 5, 6, 7, 8, 9, 10 sources may be excluded from the baked goods disclosed herein. In some examples, plant proteins from one, or more or all of the following plants may be specifically excluded: almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat and white bean.

In some such examples, the protein may be from a legume. Generally, any edible legume may be used as a source of protein. In some examples, proteins from one or more specific legumes may be excluded.

In some examples, legumes may include aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans, yuba yellow indian women beans, and others.

In some examples, plant proteins from one, or more or all of the following legumes may be specifically excluded from the baked goods disclosed herein: aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans and yuba yellow indian women beans.

In some examples, the protein may be lupine protein, including pea and/or yellow pea. The pea may be whole pea or a component of pea, standard pea (i.e., non-genetically modified pea), commoditized pea, genetically modified pea, or combinations thereof. In some examples, the pea may be Pisum sativum.

In some examples, the protein may be hypoallergenic or non-allergenic protein. Of note is that pea protein is not among the 8 significant food allergens recognized in the United States, which include milk, eggs, fish, crustacean shellfish, tree nuts, peanuts, wheat and soybeans. Pea protein is not among the 14 significant food allergens recognized in Europe. One example hypoallergenic/non-allergenic protein, therefore, includes protein sourced from pea. In some examples, the hypoallergenic or non-allergenic protein may be sourced from hemp, chia, spirulina, quinoa, teff, amaranth, buckwheat and millet. Other hypoallergenic/non-allergenic plant proteins are known in the art.

In some examples, the baked goods disclosed herein may contain no other protein or no other plant protein, except protein from peas or protein from yellow peas. In some examples, the baked goods disclosed herein may contain no other, or substantially no other protein or no other, or substantially no other plant protein, except protein from Pisum sativum.

In some examples, the protein may be from soy. The soy may be whole soy or a component of soy, standard soy (i.e., non-genetically modified soy), commoditized soy, genetically modified soy, or combinations thereof. In some examples, soy protein may be specifically excluded from the baked goods disclosed herein.

In some examples, the protein may be from chickpea. The chickpea may be whole chickpea or a component of chickpea, standard chickpea (i.e., non-genetically modified chickpea), commoditized chickpea, genetically modified chickpea, or combinations thereof. In some examples, chickpea protein may be specifically excluded from the baked goods disclosed herein.

In some examples, the protein may be from one or more microbes, including yeast. In some examples, protein from one or more specific microbes may be specifically excluded from the baked goods disclosed herein.

Plant protein (e.g., isolated protein) may contain components that negatively affect taste, texture and/or other properties of baked goods made using the protein. In some examples, the isolated protein preparation may be processed for various purposes, such as to remove components like aroma agents, coloring agents, flavoring agents and other components. In some examples, the protein may be extracted in a solvent to remove lipids and/or heat treated to remove volatiles. Examples of treatments to obtain refined protein are described in the next section of this application.

In some examples, the refined protein may have an aqueous solubility of about 50, 45, 40, 35, 30, 25, 20, 15, 10, 9, 8, 7, 6, 5, 4, 3, 2 or 1 percent (w/w). In some examples, the refined protein may have an aqueous solubility of no more than or less than about 15, 14, 13, 12, 11, 10, 9, 8, 7, 6, 5, 4, 3, 2 or 1 percent (w/w).

In some examples, the refined protein may have a solution pH of about or less than about or no more than 8.0, 7.9, 7.8, 7.7, 7.6, 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9 or 3.8.

In some examples, the refined protein may have a sodium content of about or less than about or no more than 8000, 7500, 7000, 6500, 6000, 5500, 5000, 4900, 4800, 4700, 4600, 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 11700, 1600, 1500, 1400, 1300, 1200, 1100, 1000, 950, 940, 930, 920, 910, 900, 890, 880, 870, 860, 850, 840, 830, 820, 810, 800, 790, 780, 770, 760, 750, 740, 730, 720, 710, 700, 690, 680, 670, 660, 650, 640, 630, 620, 610, 600, 590, 580, 570, 560, 550, 540, 530, 520, 510, 500, 490, 480, 470, 460, 450, 440, 430, 420, 410, 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 90, 80, 70, 60, 50, 40, 30, 20 or 10 parts per million (ppm).

The refined protein preparations may have various forms, including, but not limited to concentrate, flour, isolate, meal, paste, powder and others. The protein may be native, denatured or renatured; dried, spray dried, or not dried protein; enzymatically treated or untreated protein; and combinations thereof. The protein may consist of particles of one or more sizes and may be pure or mixed with other components (e.g., other plant source components).

In some examples, proteins processed by specific methods may be excluded from the baked goods disclosed herein. In some examples, proteins having specific forms (e.g., concentrate, flour, isolate, meal, paste, powder) may be excluded from the baked goods disclosed herein. In some examples, proteins that are denatured, renatured; dried, spray dried; enzymatically treated; of specific sizes; and/or mixed with other components, may be specifically excluded from the baked goods disclosed herein.

In some examples, the processed or refined protein may contain at least 10, 20, 30, 40, 50, 60, 70, 80 or 90 percent by weight of protein. The processed or refined protein may contain a percent by weight of protein of between 10-30, 10-20, 12-16, 20-99, 20-60, 25-95, 30-90, 30-50, 40-99, 40-95, 40-90, 40-85, 40-80, 40-75, 50-99, 50-95, 50-90, 50-85, 50-80, 60-99, 60-95, 60-90, 60-85, 60-80, 60-75, 65-99, 65-95, 65-90, 65-85, 65-80, 70-99, 70-95, 70-90, 70-85, 70-80, 75-99, 75-95, 75-90, 75-85, 75-80 and others.

In some examples, the processed/refined protein may contain carbohydrates and/or fat. In some examples, the processed/refined protein may contain calcium, phosphorous, potassium, sodium, and other cations. In some examples, the processed/refined protein may contain ash.

In some examples, the baked goods disclosed herein may specifically exclude one or more cations and/or ash.

In some examples, the refined protein may have a carbohydrate content of between 0-50% by weight. In some examples, the refined protein may have a carbohydrate content of at least 0% by weight. In certain examples, the refined protein may have a carbohydrate content of less than 25% by weight.

In some examples, the refined protein may have a starch content of between 0-10% by weight. In some examples, the refined protein may have a starch content of at least 3% by weight. In some examples, the refined protein may have a starch content of less than 9% by weight.

In some examples, the refined protein may have a fat content of between 1-30% by weight. In some examples, the refined protein may have a fat content of at least 2% by weight. In some examples, the refined protein may have a fat content of less than 25% by weight.

In some examples, the refined protein may have a calcium content of between 0-5% by weight. In some examples, the calcium content may be between about 0.1 and 2% by weight.

In some examples, the refined protein may have a phosphorus content of between 0-6% by weight. In some examples, the phosphorus content may be at least 0.1% by weight. In some examples, the refined protein may have a phosphorus content of less than 4% by weight.

In some examples, the refined protein may have a sodium and/or potassium content of less than 0.5% by weight.

In some examples, the refined protein may have an ash content of between 0-20% by weight. In some examples, the refined protein may have an ash content of at least 1% by weight.

In some examples, the refined protein may be in the form of granules. In some examples, the refined protein may be in the form of a powder. In some examples, the refined protein may be in the form of a granulated powder. In some examples, the refined protein may be a flour. In some examples, the size of particles or the mean size of particles in these forms of refined protein may be between 1 and 1000 μm, 10 and 500 μm, 50 and 350 μm, 70 and 250 μm or 100 and 150 μm. In some examples, the mean size of particles in a distribution of the particles may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size. In some examples, at least 10, 20, 30, 40, 50, 60, 70, 80, 90 or 95% of the particles these forms of refined protein may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size.

In some examples, a particle size distribution for the protein particles may be D×50 of about or less than about 200, 190, 180, 170, 160, 150, 140, 130, 120, 110, 100, 90, 80, 70, 60, 50, 40, 30, 20 or 10 μm.

In some examples, adsorption of water, the amount of water adsorbed, the rate at which water is adsorbed, and the like, may be affected by the size of the protein particles. In some examples, things like the amount and/or rate of water adsorption may be related to or proportional to the surface area, volume, surface area per unit volume, and the like, of the protein particles (e.g., granules, powder, granulated powder). In some examples, this may not be the case.

The protein preparations used herein may have some binder activity. The protein preparations used herein may have some emulsifier activity.

In some examples, at least some of the protein in the disclosed baked goods may be from eggs. In some examples, the baked goods disclosed herein may not contain eggs. In some examples, the baked goods disclosed herein may specifically exclude egg protein.

Processes for Preparing Refined Plant Protein

Various methods may be used for obtaining refined protein components from non-animal natural protein sources. The refined protein components may be used in the baked goods disclosed herein. However, isolated protein or non-refined protein components may also be used, exclusively or in combination with refined protein components.

Generally, the methods described below may remove or substantially remove components that may affect flavor, aroma, color and so on, from protein preparations, and thus make the refined protein preparations more suitable for use in the disclosed baked goods. Removal of such agents may also increase the shelf life of baked goods comprising such refined protein components.

In some examples, methods for obtaining refined protein components from non-animal natural sources may comprise one or more of the following steps, in or out of order:

a) obtaining a protein preparation from a non-animal natural source;

b) washing the protein preparation at a wash pH;

c) extracting the protein preparation at an extraction pH to obtain an aqueous protein solution;

d) separating the aqueous protein solution from non-aqueous components;

e) adding salt;

f) precipitating the protein from the aqueous protein solution at a precipitation pH to obtain a protein precipitate;

g) separating the protein precipitate from non-precipitated components; and

h) washing the protein precipitate to obtain a refined protein component (e.g., salt-precipitated protein).

Generally, it is at least steps (e) and (f) above that are used to prepare what is called herein as “salt-precipitated protein.” Additional steps may also be included in the process.

Washing the refined protein preparation may utilize various methods, including single wash, multiple washes, and/or counter-current washes.

The wash and extraction pH may be a pH that is suitable for washing and solubilizing proteins in a protein preparation. The wash pH and extraction pH may be the same, may be different or may be opposite (e.g., acidic vs. basic) one another. A suitable wash and extraction pH may be determined by testing various pH conditions, and identifying the pH condition at which the most optimal yield and quality (judged by, for example by one or more of the following: flavor, odor, color, nitrogen content, calcium content, heavy metal content, emulsification activity, molecular weight distribution, and thermal properties of the protein component obtained) of the refined protein component is obtained. In some examples, the wash and extraction pH are alkaline pH. In some such examples, the alkaline pH is at least 7.1, at least 8, at least 9, at least 10, at least 11, at least 12, between 7.1 and 10, between 8 and 10, between 9 and 10, or between 8 and 9. In some such examples, the alkaline pH is 8.5. In some examples, the wash and extraction pH are acidic pH. In some such examples, the acidic pH is less than 7, less than 6.95, less than 6.5, less than 5, less than 4, less than 3, between 2 and 6.95, between 3 and 6, or between 3 and 5. The extraction pH may be adjusted using a pH adjusting agent. In some examples, the pH adjusting agent is a food grade basic pH adjusting agent. In other examples, the pH adjusting agent is a food grade acidic pH adjusting agents. Examples of suitable acidic pH adjusting agents include, but are not limited to, phosphoric acid, acetic acid, hydrochloric acid, citric acid, succinic acid, and combinations thereof. Examples of suitable basic pH adjusting agents include, but are not limited to, potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. It may be useful to obtain substantially as much extracted protein as is practicable to provide an overall high product yield. The yield of protein in the aqueous protein solution may vary widely, wherein typical yields range from 1% to 90%. The aqueous protein solution typically has a protein concentration of between 1 g/L and 300 g/L. The molecular weight distribution of the proteins comprised in the aqueous protein solution may vary widely. Separating the aqueous protein solution from non-aqueous components may be accomplished by various methods, including but not limited to, centrifugation followed by decanting of the supernatant above the pellet, or centrifugation in a decanter centrifuge. The centrifugation may be followed by disc centrifugation and/or filtration (e.g., using activated carbon) to remove residual protein source material and/or other impurities. The separation step may be conducted at various temperatures within the range of 1° C. to 100° C. For example, the separation step may be conducted between 10° C. and 80° C., between 15° C. and 70° C., between 20° C. and 60° C., or between 25° C. and 45° C. The non-aqueous components may be re-extracted with fresh solute at the extraction pH, and the protein obtained upon clarification combined with the initial protein solution for further processing as described herein. The separated aqueous protein solution may be diluted or concentrated prior to further processing. Dilution is usually affected using water, although other diluents may be used. Concentration may be affected by membrane-based methods. In some examples, the diluted or concentrated aqueous protein solution comprises between 1 g/L and 300 g/L, between 5 g/L and 250 g/L, between 10 g/L and 200 g/L, between 15 g/L and 150 g/L, between 20 g/L and 100 g/L, or between 30 g/L and 70 g/L by weight of protein.

The protein in the aqueous protein solution may be optionally concentrated and/or separated from small, soluble molecules. Suitable methods for concentrating include, but are not limited to, diafiltration or hydrocyclonation. Suitable methods for separation from small, soluble molecules include, but are not limited to, diafiltration.

Salt precipitation may be accomplished using various suitable salts and precipitation pH. Suitable salts, salt concentrations, polysaccharides, polysaccharide concentrations, and precipitation pH may be determined by testing various conditions and identifying the salt and pH and polysaccharide conditions which obtain the most colorless and/or flavorless protein precipitates at the most optimal yield and quality (judged by, for example, by one or more of the following: flavor, odor, color, nitrogen content, calcium content, heavy metal content, emulsification activity, molecular weight distribution, and thermal properties of the protein component obtained). In some examples, salt precipitation occurs with calcium dichloride at a concentration of between 5 mM and 1,000 mM. Other examples of suitable salts include, but are not limited to, other alkaline earth metal or divalent salts (e.g., magnesium chloride, sodium chloride, calcium permanganate, and calcium nitrate). Typically, the precipitation pH is opposite the extraction pH (i.e., when the extraction pH is in the basic range, the precipitation pH is most suitable in the acidic range, and vice versa). In some examples, the precipitation pH is an acidic pH. In some such examples, the acidic pH is less than 7.1, less than 6, less than 5, less than 4, less than 3, less than 2, between 6.9 and 2, between 6 and 3, between 6 and 5, or between 5 and 4. In some such examples, the acidic pH is 5.25. The precipitation pH may be adjusted using a pH adjusting agent. In some examples, the pH adjusting agent is a food grade acidic pH adjusting agent. In other examples, the pH adjusting agent is a food grade basic pH adjusting agent.

Separating the protein precipitate from non-precipitated components may occur by one or more of the methods disclosed herein.

Washing of the protein precipitate may occur by various methods. In some examples, the washing is carried out at the precipitation pH.

The protein precipitate may optionally be suspended. In some examples, the suspending is carried out at the extraction pH, for example, in the presence of a chelator to remove calcium ions. If the suspended protein preparation is not transparent it may be clarified by various convenient procedures such as filtration or centrifugation.

The pH of the suspended color-neutral refined protein component may be adjusted to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The refined protein component may be dried. Drying may be performed in a suitable way, including, but not limited to, spray drying, dry mixing, agglomerating, freeze drying, microwave drying, drying with ethanol, evaporation, refractory window dehydration or combinations thereof.

Other optional steps in the exemplary methods are heating steps aimed at removing heat-labile contaminants and/or microbial contaminations, and additional filtering (e.g., carbon filtering) steps aimed at removing additional odor, flavor, and/or color compounds. In some examples, such additional filtering is carried out immediately after extracting the protein preparation or after separating the aqueous protein solution from the non-aqueous components.

### Amounts of Protein in Baked Good Formulations and Products

In some examples, the disclosed baked goods containing non-dairy protein are made with unrefined/non-refined proteins from plants. In some examples, the baked goods are made with processed/refined proteins from plants (e.g., salt-precipitated protein).

In some examples, protein may be included in the disclosed baked goods at amounts that are about or at least about 10, 11, 12, 13, 14, 15, 16, 17, 18, 19, 20, 21, 22, 23, 24, 25, 26, 27, 28, 29, 30, 30 or more grams per 60 grams of the baked good. In some examples, protein may be included in the disclosed baked goods at amounts that are about or at least about 16, 16.5, 17, 17.5, 18, 18.5, 19, 19.5, 20, 20.5, 21, 21.5, 22, 22.5, 23 or 23.5 or more grams per 60 grams of the baked good.

In some examples, protein may be included in the baked good formulations and/or final baked goods product at amounts that are about or between about 0-50 percent by weight. In some examples, protein may be included at amounts about or at least about 4, 5, 6, 7, 8, 9, 10, 11, 12, 13, 14, 15, 16, 17, 18, 19, 20, 21, 22, 23, 24, 25, 26, 27, 28, 29 or 30 percent by weight.

In some examples, protein may be included at amounts between about 5-10, 5-11, 5-12, 5-13, 5-14, 5-15, 5-16, 5-17, 5-18, 5-19, 5-20, 5-21, 5-22, 5-23, 5-24, 5-25, 5-26, 5-27, 5-28, 5-29, 5-30, 6-10, 6-11, 6-12, 6-13, 6-14, 6-15, 6-16, 6-17, 6-18, 6-19, 6-20, 6-21, 6-22, 6-23, 6-24, 6-25, 6-26, 6-27, 6-28, 6-29, 6-30, 7-10, 7-11, 7-12, 7-13, 7-14, 7-15, 7-16, 7-17, 7-18, 7-19, 7-20, 7-21, 7-22, 7-23, 7-24, 7-25, 7-26, 7-27, 7-28, 7-29, 7-30, 8-10, 8-11, 8-12, 8-13, 8-14, 8-15, 8-16, 8-17, 8-18, 8-19, 8-20, 8-21, 8-22, 8-23, 8-24, 8-25, 8-26, 8-27, 8-28, 8-29, 8-30, 9-10, 9-11, 9-12, 9-13, 9-14, 9-15, 9-16, 9-17, 9-18, 9-19, 9-20, 9-21, 9-22, 9-23, 9-24, 9-25, 9-26, 9-27, 9-28, 9-29, 9-30, 10-11, 10-12, 10-13, 10-14, 10-15, 10-16, 10-17, 10-18, 10-110, 10-20, 10-21, 10-22, 10-23, 10-24, 10-25, 10-26, 10-27, 10-28, 10-210, 10-30, 11-12, 11-13, 11-14, 11-15, 11-16, 11-17, 11-18, 11-111, 11-20, 11-21, 11-22, 11-23, 11-24, 11-25, 11-26, 11-27, 11-28, 11-29, 11-30, 12-13, 12-14, 12-15, 12-16, 12-17, 12-18, 12-121, 12-20, 12-21, 12-22, 12-23, 12-24, 12-25, 12-26, 12-27, 12-28, 12-29, 12-30, 13-14, 13-15, 13-16, 13-17, 13-18, 13-131, 13-20, 13-21, 13-22, 13-23, 13-24, 13-25, 13-26, 13-27, 13-28, 13-29, 13-30, 14-15, 14-16, 14-17, 14-18, 14-141, 14-20, 14-21, 14-22, 14-23, 14-24, 14-25, 14-26, 14-27, 14-28, 14-29, 14-30, 15-16, 15-17, 15-18, 15-151, 15-20, 15-21, 15-22, 15-23, 15-24, 15-25, 15-26, 15-27, 15-28, 15-29, 15-30, 16-17, 16-18, 16-161, 16-20, 16-21, 16-22, 16-23, 16-24, 16-25, 16-26, 16-27, 16-28, 16-29, 16-30, 17-18, 17-171, 17-20, 17-21, 17-22, 17-23, 17-24, 17-25, 17-26, 17-27, 17-28, 17-29, 17-30, 18-19, 18-20, 18-21, 18-22, 18-23, 18-24, 18-25, 18-26, 18-27, 18-28, 18-29, 18-30, 19-20, 19-21, 19-22, 19-23, 19-24, 19-25, 19-26, 19-27, 19-28, 19-29, 19-30, 20-21, 20-22, 20-23, 20-24, 20-25, 20-26, 20-27, 20-28, 20-29, 20-30, 21-22, 21-23, 21-24, 21-25, 21-26, 21-27, 21-28, 21-29, 21-30, 22-24, 22-26, 23-25, 22-28, 23-27, 24-26, 22-30, 23-29, 24-28, 25-27, 22-32, 23-31, 24-30, 25-29, 26-28, 23-33, 24-32, 25-31, 26-30, 27-29, 24-34, 25-33, 26-32, 27-31, 28-30, 25-35, 26-34, 27-33, 28-32, 29-31, 26-36, 27-35, 28-34, 29-33, 30-32, 27-37, 28-36, 29-35, 30-34, 31-33, 28-38, 29-37, 30-36, 31-35, 32-34, 29-39, 30-38, 31-37, 32-36, 33-35, 30-40, 31-39, 32-38, 33-37, 34-36, 31-41, 32-40, 33-39, 34-38, 35-37, 32-42, 33-41, 34-40, 35-39, 36-38, 33-43, 34-42, 35-41, 36-40, 37-39, 34-44, 35-43, 36-42, 37-41, 38-40, 35-45, 36-44, 37-43, 38-42 or 39-41 percent by weight.

In some examples, protein may be included at amounts about or at least about 4, 5, 6, 7, 8, 9, 10, 11, 12, 13, 14, 15, 16, 17, 18, 19, 20, 21, 22, 23, 24, 25, 26, 27, 28, 29 or 30 grams per 90 grams of baked good formulation or baked good product or final baked good product.

### Fatty Materials and Oils

Generally, the term used herein to refer to lipids is “fats.” In the strict sense, fats are solid at room temperature (e.g., butter) and oils, also a type of lipid, are liquid at room temperature. Herein, the term “fat” may refer to both fats and oils (i.e., all lipids). Herein, the term “fats” generally refers to non-animal fats, like fats from plants.

The fats used to make the disclosed baked goods can be from a variety of sources. In some examples, the sources are non-animal sources (e.g., oils obtained from plants, algae, fungi such as yeast or filamentous fungi, seaweed, bacteria, Archae), including genetically engineered bacteria, algae, archaea or fungi. The fats can be hydrogenated (e.g., a hydrogenated vegetable oil) or non-hydrogenated. Non-limiting examples of plant fats include almond oil, babassu oil, cashew oil, canola oil, cocoa butter, coconut cream, coconut oil, corn oil, cottonseed oil, flax seed oil, mango butter, margarine, olive oil, orrice bran oil, palm oil, palm kernel oil, peanut oil, sesame oil, rapeseed oil, safflower oil, shea butter, soy oil, sunflower oil, walnut oil, wheatgerm oil, combinations thereof, and others. In some examples, the fats can be non-dairy butter from various sources.

In some examples, the amount of fats in the baked good formulations and/or final baked good products may be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 percent by weight.

In some examples, fats may be included in the baked good formulations and/or final baked good product at amounts that are no more than about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 percent by weight.

In some examples, the amount of fats in the baked good formulations and/or final baked good products may be between about 2-8, 2-9, 2-10, 2-11, 2-12, 2-13, 2-14, 2-15, 2-16, 2-17, 2-18, 2-19, 2-20, 2-21, 2-22, 2-23, 2-24, 2-25, 2-30, 2-35, 2-40, 2-50, 3-8, 3-9, 3-10, 3-11, 3-12, 3-13, 3-14, 3-15, 3-16, 3-17, 3-18, 3-19, 3-20, 3-21, 3-22, 3-23, 3-24, 3-25, 3-30, 3-35, 3-40, 3-50, 4-8, 4-9, 4-10, 4-11, 4-12, 4-13, 4-14, 4-15, 4-16, 4-17, 4-18, 4-19, 4-20, 4-21, 4-22, 4-23, 4-24, 4-25, 4-30, 4-35, 4-40, 4-50, 5-8, 5-9, 5-10, 5-11, 5-12, 5-13, 5-14, 5-15, 5-16, 5-17, 5-18, 5-19, 5-20, 5-21, 5-22, 5-23, 5-24, 5-25, 5-30, 5-35, 5-40, 5-50, 6-8, 6-9, 6-10, 6-11, 6-12, 6-13, 6-14, 6-15, 6-16, 6-17, 6-18, 6-19, 6-20, 6-21, 6-22, 6-23, 6-24, 6-25, 6-30, 6-35, 6-40, 6-50, 6-60, 7-8, 7-9, 7-10, 7-11, 7-12, 7-13, 7-14, 7-15, 7-16, 7-17, 7-18, 7-19, 7-20, 7-21, 7-22, 7-23, 7-24, 7-25, 7-30, 7-35, 7-40, 7-50, 7-60, 8-9, 8-10, 8-11, 8-12, 8-13, 8-14, 8-15, 8-16, 8-17, 8-18, 8-19, 8-20, 8-21, 8-22, 8-23, 8-24, 8-25, 8-30, 8-35, 8-40, 8-50, 8-60, 9-10, 9-11, 9-12, 9-13, 9-14, 9-15, 9-16, 9-17, 9-18, 9-19, 9-20, 9-21, 9-22, 9-23, 9-24, 9-25, 9-30, 9-35, 9-40, 9-50, 9-60, 10-11, 10-12, 10-13, 10-14, 10-15, 10-16, 10-17, 10-18, 10-19, 10-20, 10-21, 10-22, 10-23, 10-24, 10-25, 11-12, 11-13, 11-14, 11-15, 11-16, 11-17, 11-18, 11-19, 11-20, 11-21, 11-22, 11-23, 11-24, 11-25, 12-13, 12-14, 12-15, 12-16, 12-17, 12-18, 12-19, 12-20, 12-21, 12-22, 12-23, 12-24, 12-25, 13-14, 13-15, 13-16, 13-17, 13-18, 13-19, 13-20, 13-21, 13-22, 13-23, 13-24 or 13-25 percent by weight.

In some examples, fat may be included at amounts about or less than about 4, 5, 6, 7, 8, 9, 10, 11, 12, 13, 14, 15, 16, 17, 18, 19, 20, 21, 22, 23, 24, 25, 26, 27, 28, 29 or 30 grams per 90 grams of baked good formulation or baked good product, or final baked good product.

In some examples, at least some of the fat in the disclosed baked goods may be from eggs. In some examples, the baked goods disclosed herein may not contain eggs. In some examples, the baked goods disclosed herein may specifically exclude egg protein.

In some examples, the baked good formulations and/or final baked good products may contain no lipids or fats.

### Emulsifiers

Herein, emulsions are colloidal solutions with both the dispersed phase and the dispersion medium being liquid. Emulsions can be formed from two liquids that are not miscible. In some examples, an emulsion is an oil (dispersed phase) in water (dispersion medium) emulsion. In unstable emulsions, the liquids will separate in absence of agitation.

Herein, emulsifiers are substances that stabilize emulsions. Generally, emulsifiers used in the disclosed baked good formulations and products may be emulsifiers commonly used for oil in water emulsions in baked goods. In some examples, the emulsifiers used may be lecithins. Lecithins may be from a variety of sources. Generally, the lecithins used herein are from non-animal sources. The lecithins used herein may be from plant sources. In some examples, the lecithins used herein are de-oiled lecithins. Example plant-based lecithins may be from canola, coconut, corn, cottonseed, rapeseed, soy, sunflower and other plants.

In some examples, one or more emulsifiers, including lecithins, may be included in the baked good formulations and/or final products. Generally, the emulsifiers are used in amounts that stabilize an emulsion. In some examples, emulsifiers may be present in the formulations/products at about 0.01, 0.02, 0.03, 0.04, 0.05, 0.06, 0.07, 0.08, 0.09, 0.1, 0.12, 0.14, 0.16, 0.18, 0.2, 0.22, 0.24, 0.26, 0.28, 0.3, 0.32, 0.34, 0.36, 0.38, 0.4, 0.42, 0.44, 0.46, 0.48, 0.5, 0.52, 0.54, 0.56, 0.58, 0.6, 0.62, 0.64, 0.66, 0.68, 0.7, 0.8, 0.82, 0.84, 0.86, 0.88, 0.9, 0.92, 0.94, 0.96, 0.98, 1.0, 1.1, 1.2, 1.3, 1.4, 1.5, 1.6, 1.7, 1.8 1.9 or 2.0 weight percent.

In some examples, the baked good compositions may contain no emulsifiers, may contain no emulsifiers in addition to other ingredients that may have emulsification activity, or may contain no lecithin emulsifiers.

### Leavening Agents

Generally, the baked goods disclosed herein may be baked goods containing a leavening agent. Leavening agents may include substances causing expansion of doughs and batters by the release of gases within such mixtures, resulting in baked goods with porous structure. In some examples, a leavening agent in the baked goods may be one or more of a chemical leavening agent, a biological leavening agent or a vaporous leavening agent. Such agents may include air, steam, yeast, beer, kafir, sourdough starter, baking powder, baking soda and the like.

In some examples, the leavening agent may be a chemical leavening agent. In some examples, leavening agents that are not chemical leavening agents are specifically excluded.

Chemical leavening agents may include, but may not be limited to, baking powders, which generally include baking soda (i.e., sodium bicarbonate) in combination with acids and starch. In some examples, baking soda may be used in combination with substances that provide acids (e.g., honey, sour cream, molasses, cocoa and the like). In some examples, so-called single-acting baking powders containing tartaric acid or cream of tartar may be used. In some examples, slow-acting baking powders, containing phosphates, may be used. In some examples, double-acting baking powders containing sodium aluminum sulfate and calcium acid phosphate may be used.

In some examples, chemical leavening agents may include sodium aluminium sulfate (NaAl(SO₄)₂.12H₂O), disodium pyrophosphate (Na₂H₂P₂O₇), and sodium aluminium phosphates (NaH₁₄Al₃(PO₄)₈.4H₂O and Na₃H₁₅Al₂(PO₄)₈). These compounds may combine with sodium bicarbonate to give carbon dioxide in a predictable manner.

In some examples, leavening agents may include biological leavening agents, including yeast. In some examples, leavening agents may include vaporous leavening agents.

In some examples, leavening agents may be present in the baked good formulations or in the final baked good products at amounts or less than amounts that are about 0.1, 0.2, 0.3, 0.4, 0.5, 0.6, 0.7, 0.8, 0.9, 1.0, 1.1, 1.2, 1.3, 1.4, 1.5, 16, 1.7, 1.8, 1.9, 2.0, 2.1, 2.2, 2.3, 2.4, 2.5, 2.6, 2.7, 2.8, 2.9, 3.0, 3.2, 3.4, 3.6, 3.8, 4.0, 4.4, 4.8, 5.2, 5.6, 6.0, 6.5, 7.0, 7.5, 8.0, 8.5, 9.0 or 10 percent by weight.

In some examples, one or more groups of leavening agents (e.g., chemical, biological, vaporous), or specific leavening agents within one or more groups of leavening agents, may be specifically excluded from the baked goods disclosed herein. In some examples, the baked goods disclosed herein may not contain a leavening agent.

### Sweetening Agents

Sweetening agents may be used in the baked goods disclosed herein. In some examples, the sweetening agents may be carbohydrates, sugars for example. In some examples, the sweetening agents may not be carbohydrates. Example sweetening agents for use in baked goods are known in the art. Some exemplary sweetening agents may include glycerin, erythritol, stevia, monk fruit, and others. Individual sweetening agents may be used individually or in combination.

In some examples, sweetening agents may be present in the baked good formulations or in the baked good products at levels that are about or less than about 2, 2.5, 3.0, 3.5, 4.0, 4.5, 5.0, 5.5, 6.0, 6.5, 7.0, 7.5, 8.0, 9.5 or 10 percent by weight.

In some examples, the baked goods disclosed herein may contain no sweetening agents.

### Salt

In some examples, one or more salts are used. In some examples, the salt may be sea salt. In some examples, the salt may be table salt. In some examples, the salt may be added to the baked good formulation or be present in the final baked good product at amounts about or less than about 0.0001, 0.0002, 0.0003, 0.0004, 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.20, 0.22, 0.24, 0.26, 0.28, 0.30, 0.35, 0.40, 0.45, 0.50, 0.55 or 0.60 percent by weight.

In some examples, the salt may be sodium salt. In some examples, the salt may be calcium or other cationic salts.

In some examples, the salt may have emulsifier activity.

In some examples, the baked goods disclosed herein may contain no salt.

### Thickening Agents

Generally, thickening agents refer to substances that increase the viscosity of a liquid (e.g., a batter). Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

Herein, other components of the formulations and/or compositions disclosed herein (e.g., starch, protein) may functionally act to thicken liquid formulations of the baked goods described herein. Generally, the substances described in this section are added to the formulations to provide additional thickening.

Many different types of thickening agents may be used. Generally, any thickening agent that is acceptable for use in a baked good can be used. Usable thickening agents may include polysaccharides, like starches, vegetable gums, pectin and others. Combinations of thickening agents may be used.

In some examples, the thickening agent may be fecula, including almond flour, arrowroot, cornstarch, katakuri starch, potato starch, sago, tapioca, wheat flour and their starch derivatives. Microbial and vegetable gums used as food thickeners may include alginin, guar gum, locust bean gum, xanthan gum and the like. Proteins used as food thickeners may include certain non-dairy proteins. Sugar polymers include may include agar, carrageenan, carboxymethyl cellulose, pectin and the like.

In some examples, the thickening agent may include a “high acyl gellan gum.” High acyl gellan gum, as used herein, is a polymer comprising various monosaccharides linked together to form a linear primary structure and the gum gels at temperatures of greater than 60° C. The properties of the high acyl gellan gum polymer may vary depending at least in part on its source, how it was processed, and/or the number and type of acyl groups present on the polymer.

Gellan gum is a gel-forming polysaccharide produced by the microbe Sphingomonas elodea. There are several sources of suitable high acyl gellan gums, for example, Ticagel Gellan HS, TIC gums, KELCOGEL High Acyl Gellan Gum, CP Kelco, Gellan Gum LT100 and Modernist Pantry. Gellan polymers typically consist of monosaccharides beta-d-glucose, beta-d-glucuronic acid and alpha-1-rhamnose in approximate molar ratios of 2:1:1 linked together to form a linear primary structure.

In some examples, the thickening agent may include xanthan gum.

In some examples, the thickening agent(s) may be included in the disclosed baked goods at amounts that are about, at least about, or no greater than about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, 3.0, 3.5, 4.0, 4.5 or 5 percent on a weight basis.

In some examples, the thickening agent(s) may be included in the disclosed baked goods at amounts that are or are between about 0.1-1, 0.1-0.9, 0.1-0.8, 0.1-0.7, 0.1-0.6, 0.1-0.5, 0.1-0.4, 0.1-0.3, 0.1-0.2, 0.2-1, 0.2-0.9, 0.2-0.8, 0.2-0.7, 0.2-0.6, 0.2-0.5, 0.2-0.4, 0.2-0.3, 0.3-1, 0.3-0.9, 0.3-0.8, 0.3-0.7, 0.3-0.6, 0.3-0.5, 0.3-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.6-0.6, 0.7-1, 0.7-0.9, 0.7-0.8, 0.8-1, 0.8-0.9 or 0.9-1.0 weight percent.

In some examples, the baked goods may contain no thickening agents.

### Flavoring Agents

Flavors may be used in the baked goods disclosed herein. Different flavors may be used. Example flavoring agents may include cookie dough flavoring, vanilla extract, lemon zest and the like.

In some examples, the disclosed baked goods may contain no flavoring agents.

### Other Ingredients

The baked goods disclosed herein may contain inclusions. An example inclusion includes chocolate chips, fruit pieces, nuts, seeds and the like.

The baked goods disclosed herein may contain added nutrients. Example nutrients may include vitamin A, vitamin B, Vitamin B2, vitamin B6, vitamin B12, vitamin C, vitamin D, vitamin E, vitamin K, biotin, carnitine, taurine, folic acid, pantothenic acid, niacin, choline, calcium, phosphorus, magnesium, zinc, manganese, copper, sodium, potassium, chloride, iron, selenium, chromium, molybdenum, omega-3 fatty acid and the like.

The baked goods disclosed herein may include coloring agents.

### Methods of Making Baked Goods

Generally, the process of making the disclosed baked goods involves combining and mixing the ingredients to obtain the formulation and baking the formulation to obtain the final baked good products.

In some cases, all ingredient components are mixed at once. In some cases, certain components are mixed sequentially. In some examples, liquid components may be initially mixed and dry components may be added to the liquid components, or the liquid may be poured over the dry components. In some instances, an emulsion is formed. Other ingredients may be added before or after formation of the emulsion. Emulsifiers may or may not be added.

In some examples, the ingredients are combined and mixed well. In some examples, the ingredients are combined and not mixed so well or mixed moderately (i.e., the ingredients are not over mixed). As is known in the art of baking, a batter beaten or mixed well (e.g., until it is smooth and fluffy) may result in a baked good with a lighter texture (e.g., a cupcake) than a baked good (e.g., a muffin) made from the same or similar batter that is mixed moderately (only until it is lumpy). Less mixing generally results in a denser baked good. Mixing the ingredients may be accomplished using a variety of mixing devices.

After mixing, the batter or dough may be baked. Often, the batter/dough is placed into a pan or on a baking sheet and then baked. Parameters involved in baking include time, temperature, humidity, air flow (convention systems), heat flux and the like. These process variables are a function of the size, unit weight, formulation, water absorption, type and target characteristics of the finished product among others.

In some examples, baking times may range from 2-60 minutes. In some examples, for quick breads, baking may be for 10-60 minutes between 250- and 450-degrees Fahrenheit.

In some examples, when a toothpick is stuck into and pulled out of a good (e.g., muffin) during the baking process, the baking process may be considered complete when the toothpick comes out of the baked good clean, without any material stuck to the toothpick.

Generally, baking may be described as having multiple stages. In some examples, baking may be described as having the following stages: i) formation and expansion of gases (oven spring); ii) drying of the surface (setting of the structure); and iii) crust formation/browning.

In some examples, including instances in which chemical leavening agents are used, baking may undergo changes in response to differences in the type and/or amounts of ingredients in the formulation. Chemical reactions and/or physical transitions during baking may be affected by things like:

a) The water content of the formulation (e.g., hydration of flour and other dry ingredients) which creates a liquid or fluid batter;

b) Ratio of flour to sugar, which may affect starch gelatinization, protein coagulation and water evaporation; lower flour content may require higher levels of structure-building ingredients (e.g., whole eggs);

c) Richer formulations (e.g., higher content of soluble solids, like sugar, fat, and the like) that may shift the formulation towards an aerated oil-in-water emulsion (i.e., batter);

d) Different leavening agents that may need specific conditions of temperature and/or available water; and

e) Modification of pH due to presence of chemical leavening agents that can affect color of baked good (e.g., crust) and/or taste of final product.

Generally, the baking process results in weight loss of the batter or dough, due to loss of moisture and, in some examples, volatile organic compounds. As such, the percent of ingredients on a weight basis in the formulation may be changed in the final product.

Generally, the process used to make the baked goods disclosed herein result in a visually homogeneous baked good. In some instances, the baked good may include one or more inclusions which may be visible to human eye.

### Properties of Baked Goods

Generally, the baked goods disclosed herein, that contain the plant-based, salt-precipitated protein, are able to form into a baked good (e.g., without collapsing) with relatively higher amounts of protein as compared to baked goods using plant-based protein not prepared by the salt-precipitation method. In some examples, the baked goods may contain plant-based protein that may not be salt-precipitated but may have certain or certain ranges of particle sizes (e.g., D×50), aqueous solubilities, solution pH and/or sodium contents. In some examples, the baked goods may contain salt-precipitated plant-based protein that may also have certain or certain ranges of particle sizes (e.g., D×50), aqueous solubilities, solution pH and/or sodium contents. In some examples, the baked goods may contain salt-precipitated plant-based protein that may also have certain or certain ranges of particle sizes (e.g., D×50), aqueous solubilities, solution pH and sodium contents. In some examples, the ability of this protein to produce formed (e.g., not collapsed) baked goods at relatively high amounts may be particularly applicable to more dense baked goods (e.g., muffins) than to less dense baked goods (e.g., cupcakes). In some examples, the baked goods disclosed herein may have densities of about, no more than about, or no less than about 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.8, 0.81, 0.82, 0.83, 0.84, 0.85, 0.86, 0.87, 0.88, 0.89 or 0.90 g/ml or g/cm³.

Table 3 in Example 2 of this disclosure shows that formed muffins (i.e., not collapsed) could be made with the salt-precipitated pea protein at levels of about 13 grams of protein per 90-gram muffin (Sample A). Using two other commercially-available pea protein preparations, formed muffins (i.e., not collapsed) could not be made with this recipe at protein levels of 11 grams of protein per 90 gram muffin (Sample B that used Competitor #1 protein) or at protein levels of 9 grams of protein per 90 gram muffin (Sample C that used Competitor #2 protein). Table 5, in Example 4 of this disclosure notes that muffin batters made with either Competitor #1 (Sample B) or Competitor #2 (Sample C) proteins had a higher water adsorption rate, and required more water, than the muffins made with the salt-precipitated protein (Sample A). The increased water was noted to reduce the amount of protein in the batter and muffins.

Also noted in Table 5 is that the muffins made with the salt-precipitated protein (Sample A) had a more neutral taste than the muffins made with either the Competitor #1 protein (Sample B) or Competitor #2 protein (Sample C).

These data indicated that relatively higher levels of salt-precipitated proteins can be incorporated into and form baked goods (e.g., muffins) as compared to proteins prepared by other methods. The baked goods are non-allergenic/hypoallergenic, have good visual appearance, neutral taste and aroma and good texture.

### Embodiments

The numbered paragraphs below describe various embodiments of the inventions disclosed herein.

1. A baked good, comprising, consisting essentially of or consisting of or at least 8, 9, 10, 11, 12, 13, 14, 15, 16, 17, 18, 19 or 20 grams of non-dairy protein in 90 grams of the baked good.

2. The baked good of paragraph 1, wherein the non-dairy protein is from a plant source.

3. The baked good of one of paragraphs 1 or 2, wherein the non-dairy protein is from a non-allergenic source.

4. The baked good of any one of paragraphs 1-3, wherein the non-dairy protein is from a legume source.

5. The baked good of any one of paragraphs 1-4, wherein the non-dairy protein is from a pea source.

6. The baked good of any one of paragraphs 1-5, wherein the non-dairy protein is from a Pisum L. genus source.

7. The baked good of any one of paragraphs 1-6, wherein the non-dairy protein is from Pisum sativum L.

8. The baked good of any one of paragraphs 1-7, wherein the non-dairy protein is calcium-precipitated protein.

9. The baked good of any one of paragraphs 1-8, wherein the non-dairy protein has an aqueous solubility of less than about 15, 14, 13, 12, 11, 10, 9, 8, 7, 6, 5, 4, 3, 2 or 1% (w/w).

10. The baked good of any one of paragraphs 1-9, wherein the non-dairy protein has a solution pH of less than about 7.1, 7.0, 6.9, 6.8, 6.7, 6.6, 6.5, 6.4, 6.3, 6.2, 6.1, 6.0, 5.9, 5.8. 5.7, 5.6 or 5.5.

11. The baked good of any one of paragraphs 1-10, wherein the non-dairy protein has a sodium content of less than about 4500, 4000, 3500, 3000, 2500, 2000, 1500, 1000, 900 or ppm.

12. The baked good of any one of paragraphs 1-11, wherein the baked good contains no eggs.

13. The baked good of any one of paragraphs 1-12, wherein the non-dairy protein is the only protein in the baked good.

14. The baked good of any one of paragraphs 1-13, wherein the baked good is leavened.

15. The baked good of any one of paragraphs 1-14, wherein the baked good is formed (i.e., not collapsed).

16. The baked good of any one of paragraphs 1-15, comprising a chemical leavening agent.

17. The baked good of any one of paragraphs 1-16, comprising a chemical leavening agent selected from the group consisting of baking powder, baking soda and cream of tartar.

18. The baked good of any one of paragraphs 1-17, wherein the baked good does not contain a biological leavening agent.

19. The baked good of any one of paragraphs 1-18, wherein the baked good includes a quick bread.

20. The baked good of any one of paragraphs 1-19, wherein the baked good is denser than a cupcake made from the same batter or dough from which the baked good is made.

21. The baked good of any one of paragraphs 1-20, wherein the baked good includes a muffin.

22. The baked good of any one of paragraphs 1-21, wherein the baked good does not include a cupcake.

23. The baked good of any one of paragraphs 1-22, wherein the baked good is homogeneous.

24. The baked good of any one of paragraphs 1-22, wherein the baked good includes inclusions.

25. The baked good of any one of paragraphs 1-24, wherein the baked good includes about or includes no more than about 170, 180, 190, 200, 210, 220, 230 or 250 calories in 90 grams of the baked good.

26. The baked good of any one of paragraphs 1-25, wherein the baked good includes about or includes no more than about 15, 16, 17, 18, 19, 20, 21 or 22 grams carbohydrate in grams of the baked good.

27. The baked good of any one of paragraphs 1-26, wherein the baked good includes about or includes no more than about 1, 2, 3, 4, 5, 6, 7, 8, 9, 10, 11 or 12 grams of fat in 90 grams of the baked good.

28. A quick bread, comprising, consisting essentially of or consisting of or greater than 8, 9, 10, 11, 12, 13, 14, 15, 16, 17, 18, 19 or 20 grams of refined, salt-precipitated plant protein per 90 grams of the baked good.

29. The quick bread of paragraph 28, wherein the salt includes a calcium salt.

30. The quick bread of one of paragraphs 28 or 29, wherein the salt-precipitated plant protein is precipitated at an acidic pH.

31. The quick bread of any one of paragraphs 28-30, wherein the salt-precipitated plant protein is prepared by a process comprising, consisting essentially of or consisting of:

a) obtaining a protein preparation from a plant;

b) washing the protein preparation at a wash pH;

c) extracting the protein preparation at an extraction pH to obtain an aqueous protein solution;

d) separating the aqueous protein solution from non-aqueous components;

e) adding salt and adjusting the aqueous protein solution to a precipitation pH to precipitate protein and obtain a protein precipitate;

f) separating the protein precipitate from non-precipitated components; and

g) washing the protein precipitate to obtain the salt-precipitated protein.

32. The quick bread of paragraph 31, wherein the salt added is calcium dichloride at a concentration between about 50 mM and about 100 mM.

33. The quick bread of one of paragraphs 31 or 32, wherein the precipitation pH is between about 5 and 6.

34. The quick bread of any one of paragraphs 31-33, wherein the plant protein has an aqueous solubility of less than about 15, 14, 13, 12, 11, 10, 9, 8, 7, 6, 5, 4, 3, 2 or 1% (w/w).

35. The quick bread of any one of paragraphs 28-34, wherein the plant protein has a solution pH of less than about 7.1, 7.0, 6.9, 6.8, 6.7, 6.6, 6.5, 6.4, 6.3, 6.2, 6.1, 6.0, 5.9, 5.8. 5.7, 5.6 or 5.5.

36. The quick bread of any one of paragraphs 28-35, wherein the plant protein has a sodium content of less than about 4500, 4000, 3500, 3000, 2500, 2000, 1500, 1000, 900 or ppm.

37. The quick bread of any one of paragraphs 28-36, wherein the plant protein is from a legume.

38. The quick bread of any one of paragraphs 28-37, wherein the plant is pea.

39. The quick bread of any one of paragraphs 28-38, wherein the quick bread includes about or includes no more than about 170, 180, 190, 200, 210, 220, 230 or 250 calories in 90 grams of the quick bread.

40. The quick bread of any one of paragraphs 28-39, wherein the quick bread includes about or includes no more than about 15, 16, 17, 18, 19, 20, 21 or 22 grams carbohydrate in grams of the quick bread.

41. The quick bread of any one of paragraphs 28-40, wherein the quick bread includes about or includes no more than about 1, 2, 3, 4, 5, 6, 7, 8, 9, 10, 11 or 12 grams of fat in 90 grams of the quick bread.

42. The quick bread of any one of paragraphs 28-41, wherein the quick bread is selected from the group consisting of non-yeast leavened breads, biscuits, brownies, non-yeast leavened cakes, cookies, cornbreads, crusts, donuts, muffins, pancakes, scones, soda breads and waffles.

43. The quick bread of any one of paragraphs 28-42, wherein the quick bread includes a homogeneous quick bread.

44. The quick bread of any one of paragraphs 28-42, wherein the quick bread includes inclusions.

45. A muffin, comprising, consisting essentially of or consisting of or greater than 8, 9, 10, 11, 12, 13, 14, 15, 16, 17, 18, 19 or 20 grams of pea protein per 90 grams of the muffin.

46. The muffin of paragraph 45, wherein the pea protein is calcium salt-precipitated at an acidic pH.

47. The muffin of one of paragraphs 45 or 46, wherein the pea protein has an aqueous solubility of less than about 15, 14, 13, 12, 11, 10, 9, 8, 7, 6, 5, 4, 3, 2 or 1% (w/w).

48. The muffin of any one of paragraphs 45-47, wherein the pea protein a solution pH of less than about 7.1, 7.0, 6.9, 6.8, 6.7, 6.6, 6.5, 6.4, 6.3, 6.2, 6.1, 6.0, 5.9, 5.8, 5.7, 5.6 or 5.5.

49. The muffin of any one of paragraphs 45-48, wherein the pea protein has a sodium content of less than about 4500, 4000, 3500, 3000, 2500, 2000, 1500, 1000, 900 or 800 ppm.

50. The muffin of any one of paragraphs 45-49, wherein the muffin includes about or includes no more than about 170, 180, 190, 200, 210, 220, 230 or 250 calories in 90 grams of the muffin.

51. The muffin of any one of paragraphs 45-50, wherein the muffin includes about or includes no more than about 15, 16, 17, 18, 19, 20, 21 or 22 grams carbohydrate in 90 grams of the muffin.

52. The muffin of any one of paragraphs 45-51, wherein the muffin includes about or includes no more than about 1, 2, 3, 4, 5, 6, 7, 8, 9, 10, 11 or 12 grams of fat in 90 grams of the muffin.

53. The muffin of any one of paragraphs 45-52, wherein the muffin is a homogeneous muffin.

54. The muffin of any one of paragraphs 45-52, wherein the muffin includes inclusions.

55. A method for making the baked good, quick bread or muffin of any one of paragraphs 1-54.

56. A formulation of a batter or dough which, upon mixing and baking, becomes a formed baked good, the formulation comprising:

a non-dairy salt-precipitated plant protein at 10 or more percent by weight; and

one or more chemical leavening agents as the only leavening agents at 1.8 or less percent by weight.

### Examples

The studies described in these Examples relate to use of three different non-dairy refined protein preparations to make baked goods (e.g., muffins). The refined protein preparations used included a salt-precipitated protein preparation, as described herein and in U.S. Patent Publication No. 2019/0000112 A1, which was used to make the baked goods containing non-dairy protein that are the subject of this patent application. The salt-precipitated protein preparations used in these studies were from yellow pea (Pisum sativum) plants and were precipitated using calcium-based salts.

The refined protein preparations used also included two commercially available yellow pea (Pisum sativum) protein preparations, as controls. Characterization of the three different non-dairy refined protein preparations is shown in Example 1. Examples 2-4 describe making and characterization of baked goods using the three different protein preparations.

The following Examples are for illustrating various embodiments and are not to be construed as limitations.

### Example 1: Refined Protein Preparations

Three different refined protein preparations were used in these studies to produce baked goods. The first, a salt-precipitated protein preparation, is the protein preparation used to make the inventive baked goods that are the subject of this patent application. This protein preparation is from pea plants. This preparation contained approximately 88% protein. Two other commercially available refined protein preparations, also from pea plants, were used to make baked goods. These two refined protein preparations are referred to herein as Competitor #1 (approximately 86% protein) and Competitor #2 (approximately 89% protein) refined protein preparations. All three refined protein preparations were in powder form. The three refined protein preparations were characterized as described below.

In one set of studies, the particle size distribution (D×50) for each refined protein preparation was determined and is shown in Table 1. Although not shown, the distribution of particle sizes for each protein preparation was unimodal and roughly symmetrical.

Solubility in water was also determined for each protein preparation and is shown in Table 1. To determine solubility, a 5% protein load was added to 10 ml of water at room temperature and a slurry was made. After 30 minutes, the slurry was centrifuged and the amount of protein in the supernatant was determined using a combustion method. Solubility was calculated.

The pH of water that contained a 10% (w/w) solution of the refined protein preparations was determined and is shown in Table 1. To make this determination, water was supersaturated with the protein preparation at 10% (w/w) and pH of the solution was then determined.

Finally, the amount of sodium, on a ppm basis, was determined for each protein preparation and is shown in Table 1.

TABLE 1
Properties of Refined Proteins Used in Baked Goods

| | | Aqueous | Solution | Sodium |
|---|---|---|---|---|
| Protein | Dx50 | Solubility | pH | Content |
| Preparation | (μm) | (% w/w) | (10% w/w) | (ppm) |
| Salt-precipitated protein | 50 | 2 | 5.5 | 802 |
| Competitor #1 | 114 | 21 | 7.4 | 7530 |
| Competitor #2 | 36 | 15 | 7.1 | 4640 |

The data showed that the salt-precipitated protein preparation had a particle size (50 μm) smaller than the particle size of Competitor #1 (114 μm) and larger than the size of Competitor #2 (36 μm). The aqueous solubility of the salt-precipitated protein (2%) was less than the aqueous solubility of both Competitor #1 (21%) and Competitor #2 (15%) protein preparations. The pH of a 10% solution of the salt-precipitated protein (5.5) was less than a 10% solution of both Competitor #1 (7.4) and Competitor #2 (pH 7.1) protein preparations. Also, the sodium content of the salt-precipitated protein (802 ppm) was less than that of both Competitor #1 (7530 ppm) and Competitor #2 (4640 ppm) protein preparations.

### Example 2: Baked Good Ingredients and Formulations

This study was designed to produce muffins containing approximately 10-12 grams of protein per 90-110-gram muffin. The muffins were designed to be frozen and slacked (i.e., baked long enough to set, but not long enough to fully brown).

An example non-dairy protein-containing baked good (i.e., muffins) ingredient formulation is set forth below. Table 2 shows ranges of classes of ingredients used in the muffins made in these Examples using the salt-precipitated protein, Competitor #1 or #2 protein preparations as shown in Table 1 of Example 1.

TABLE 2
Classes of Ingredients in Example Muffin Formulations

| Ingredient | Weight % Range |
|---|---|
| Carbohydrate | 11.9-15.3 |
| Refined protein preparation | 10.9-14.1¹ |
| Fat | 7.1-9.2 |
| Leavening agent | 1.2-1.6 |
| Sweetening agent | 4.7-6.1 |
| Salt | 0.1-0.2 |
| Flavoring agent | 5.9-7.6 |
| Thickening agent | <0.1 |
| Water | 45.9-58.1 |
| Total | 100 |

¹Depending on the refined protein component used, the indicated amounts of refined protein preparation resulted in between about 9 and 13 g protein per 90 g muffin.

Table 3 shows specific ingredients for samples of the disclosed muffin baked goods that were prepared using the salt-precipitated protein and the competitor proteins. As shown in Table 3, the Sample A muffin (salt-precipitated protein) contained about 13 g of protein in a 90 g muffin, the Sample B muffin (Competitor #1 protein) contained about 11 g protein in a 90 g muffin, and the Sample C muffin (Competitor #2 protein) contained about 9 g protein in a 90 g muffin.

TABLE 3
Muffin Formulations

| | Ingredient Group | Sample A | Sample B | Sample C |
|---|---|---|---|---|
| Ingredient | (from Table 2) | Weight % | Weight % | Weight % |
| Cake flour | Carbohydrate | 15.3 | 13.2 | 11.9 |
| Refined pea | Protein | 14.1¹ | 12.1² | 10.9³ |
| protein | | | | |
| Canola oil | Fat | 9.2 | 7.9 | 7.1 |
| Cream of tartar | Leavening agent | 1.1 | 0.9 | 0.8 |
| Baking soda | Leavening agent | 0.5 | 0.5 | 0.4 |
| Granulated sugar | Sweetening agent | 6.1 | 5.3 | 4.7 |
| Table salt | Salt | 0.2 | 0.2 | 0.1 |
| Blueberries (IQF) | Flavoring agent | 6.9 | 5.9 | 5.3 |
| (inclusion) | | | | |
| Vanilla extract | Flavoring agent | 0.6 | 0.5 | 0.5 |
| (3x) | | | | |
| Lemon zest | Flavoring agent | 0.1 | 0.1 | 0.1 |
| (fresh) | | | | |
| Xanthan gum | Thickening agent | <0.1 | <0.1 | <0.1 |
| Water | Water | 45.9 | 53.4 | 58.1 |
| | Total | ~100 | ~100 | 100 |
| | | (100.1) | (100.1) | |

¹The indicated amount of refined protein preparation (salt-precipitated protein) resulted in about 13 g (12.7 g) protein per 90 g muffin.
²The indicated amount of refined protein preparation (Competitor #1 protein) resulted in about 11 g protein (10.6 g) per 90 g muffin.
³The indicated amount of refined protein preparation (Competitor #2 protein) represented about 9 g protein (9.2 g) per 90 g muffin.

Table 4, below, shows the nutritional compositions for 90 g muffins of Samples A-C.

TABLE 4
Nutrition Fact Panel (for a 90 g serving size)

| Property | Sample A | Sample B | Sample C |
|---|---|---|---|
| Calories per 90 g muffin | 220 | 200 | 180 |
| protein (g) | 13 | 11 | 9 |
| Total carbohydrate (g) | 20 | 17 | 16 |
| Carbohydrate as fiber (g) | 1 | 1 | 0 |
| Carbohydrate as sugar (g) | 7 | 6 | 5 |
| Total fat (g) | 10 | 9 | 8 |
| Saturated fat (g) | 1 | 1 | 0.5 |
| Trans fat (g) | 0 | 0 | 0 |
| Cholesterol (mg) | 0 | 0 | 0 |
| Sodium (mg) | 290 | 230 | 210 |

### Example 3: Process for Making Muffins

An example process for making the muffins containing non-dairy proteins (i.e., Samples A, B and C) is set forth below:

a) electric oven was pre-heated to 375° F.;

b) line muffin pan with paper liners;

c) weigh wet ingredients together;

d) pour wet ingredients over dry ingredients and whisk to make homogeneous batter;

e) add lemon zest and frozen blueberries to batter, and mix with a spatula to evenly distribute without overmixing;

f) weigh 100 grams of batter into each muffin liner;

g) bake for 30 minutes or until toothpick inserted into center comes out clean and top of muffin is starting to brown;

h) cool for 5 minutes and then remove muffins from muffin pan; allow muffins to cool to room temperature; and

i) package and seal muffins; place in freezer.

### Example 4: Characteristics

Muffin baked goods containing non-dairy protein, with the ingredients as shown in Examples 1 and 2 and prepared using the method shown in Example 3, were compared and characterized as shown in Table 5, below. As described in Example 2, Sample A (13 g protein in a 90 g muffin) was made using salt-precipitated pea protein. Samples B (11 g protein in a 90 g muffin) and C (9 g protein in a 90 g muffin) were made using two different refined pea protein preparations that are commercially available (Competitor #1 and Competitor #2, respectively). Photographs of Samples A, B, and C are shown in FIGS. 1A, 1B and 1C, respectively.

TABLE 5
Observations Made on Muffins

| Property | Sample A | Sample B | Sample C |
|---|---|---|---|
| Protein preparation | Salt-precipitated | Competitor #1 | Competitor #2 |
| Amount protein | 13 g/90 g muffin | 11 g/90 g muffin | 9 g/90 g muffin |
| Observations related to | None | Competitor #1 protein | Competitor #2 protein |
| protein in the muffins | | preparation had higher | preparation had higher |
| | | water adsorption rate | water adsorption rate |
| | | than salt-precipitated | than salt-precipitated |
| | | protein and required | protein and required |
| | | increased water in | increased water in |
| | | batter which reduced | batter which reduced |
| | | amount of protein | amount of protein |
| Appearance of muffins | Typical of a muffin | Collapsed, darker | Collapsed, pale |
| Taste | Neutral | Pea forward, bitter | Pea forward, raw |
| | | aftertaste | flavor |
| Aroma | Vanilla, blueberry | Pea forward, savory | Neutral |
| | | notes | |
| Texture | Powdery, slightly | Gelled, dense | Gelled, dense |
| | gelled but aerated | | |
| Performance in | Worked well, typical | Did not work | Did not work |
| application | of protein meant for | | |
| | baking application | | |

The refined, salt-precipitated protein used to make the muffins disclosed herein (Sample A), as well as the two different competitor refined proteins used to make Samples B and C, were from pea. These studies showed that the salt-precipitated pea protein used to make Sample A was the only refined protein of the three pea protein preparations that could be used at amounts of 9-11 g per 90 g muffin or higher, without resulting in a muffin that collapsed and did not retain a shape typical of a muffin. In Sample A, the disclosed refined protein was present at almost 13 g per 90 g muffin.

Regarding taste, it was found that the Sample A muffin, which used the salt-precipitated pea protein (i.e., calcium-precipitated), had a more neutral and clean overall taste. The taste of the Sample A muffin was less beany, less bitter and/or less raw than the Sample B and C muffins. Therefore, even though flavoring agents were used in the muffins made herein, there may be less need for use of flavoring agents or flavor maskers when salt-precipitated protein is used in the muffins.

1. A non-dairy baked good, comprising at least 9 grams of a refined non-dairy protein in 90 grams of the non-dairy baked good;
wherein the refined non-dairy protein has an aqueous solubility of less than about 15% (w/w); and
wherein the refined non-dairy protein is the only refined protein in the non-dairy baked good.

2. The non-dairy baked good of claim 1, wherein the non-dairy baked good includes a leavening agent.

3. The non-dairy baked good of claim 2, wherein the non-dairy baked good includes a chemical leavening agent.

4. The non-dairy baked good of claim 2, wherein the non-dairy baked good is not collapsed.

5. The non-dairy baked good of claim 1, wherein the refined non-dairy protein is from a plant source.

6. The non-dairy baked good of claim 1, wherein the refined non-dairy protein is from a non-allergenic source.

7. The non-dairy baked good of claim 1, wherein the refined non-dairy protein is calcium-precipitated protein.

8. The non-dairy baked good of claim 7, wherein the refined non-dairy protein is precipitated at an acid pH.

9. (canceled)

10. The non-dairy baked good of claim 1, wherein the refined non-dairy protein has a solution pH of less than about 7.1.

11. The non-dairy baked good of claim 1, wherein the refined non-dairy protein has a sodium content of less than about 4500 ppm.

12. The non-dairy baked good of claim 1, wherein the non-dairy baked good contains no eggs.

13. The non-dairy baked good of claim 1, wherein the non-dairy baked good includes no more than about 230 calories in 90 grams of the non-dairy baked good.

14. The non-dairy baked good of claim 1, wherein the non-dairy baked good includes a muffin.

15. The non-dairy baked good of claim 1, wherein the refined non-dairy protein is prepared by a process comprising:
a) obtaining a protein preparation from a plant;
b) washing the protein preparation at a wash pH of between 3 and 5;
c) extracting the protein preparation at an extraction pH of between 8 and 9 to obtain an aqueous protein solution;
d) separating the aqueous protein solution from non-aqueous components;
e) adding salt and adjusting the aqueous protein solution to a precipitation pH of between 5 and 6 to precipitate protein and obtain a protein precipitate;
f) separating the protein precipitate from non-precipitated components; and
g) washing the protein precipitate to obtain the refined non-dairy protein.

16. A method for making the non-dairy baked good of claim 1, comprising:
combining ingredients, including at least the refined non-dairy protein and a leavening agent;
mixing the combined ingredients; and
baking the mixed ingredients to obtain the non-dairy baked good.

17. A non-dairy batter which, upon baking, becomes a formed non-dairy baked good, the non-dairy batter comprising:
a refined non-dairy salt-precipitated plant protein having an aqueous solubility of less than about 15% (w/w) and a solution pH of less than about 7.1, at 10 or more percent by weight in the non-dairy batter; and
one or more chemical leavening agents as the only leavening agents at 1.8 or less percent by weight in the non-dairy batter;
wherein the refined non-dairy salt-precipitated plant protein is the only refined protein in the non-dairy batter.

18. The non-dairy batter of claim 17, wherein the refined non-dairy salt-precipitated plant protein is the only protein in the non-dairy batter.

19. The non-dairy baked good of claim 1, wherein the refined non-dairy protein is a plant protein from one plant source.

20. The non-dairy baked good of claim 1, wherein the refined non-dairy protein is the only protein in the non-dairy baked good.
